(19) United States
(12) Patent Application Publication
(10) Pub. No.: US 2025/0048081 A1
(43) Pub. Date: Feb. 6, 2025

(54) SYSTEMS, APPARATUSES, METHODS, AND COMPUTER PROGRAM PRODUCTS FOR OPTIMIZING BATTERY CONSUMPTION RATE OF A MOBILE DEVICE

(71) Applicant: Hand Held Products, Inc., Charlotte, NC (US)

(72) Inventors: Jayanthi MAHALAKSHMI, Charlotte, NC (US); Jayasree TOLETI, Charlotte, NC (US)

(21) Appl. No.: 18/775,683

(22) Filed: Jul. 17, 2024

(30) Foreign Application Priority Data
Jul. 31, 2023 (IN) 202311051294

(51) Int. Cl. H04W 8/22

(52) U.S. Cl. CPC H04W 8/22

(57) ABSTRACT

Systems, apparatuses, methods, and computer program products are provided. A method may include identifying map data representing a physical layout of a building and one or more locations in the building. In some embodiments, the method may include determining that a mobile device is moving from a first location of the one or more locations in the building to a second location of the one or more locations in the building using one or more inertial sensors associated with the mobile device. In some embodiments, the method may include switching the mobile device from an active state to an inactive state. In some embodiments, the method may include determining that the mobile device has reached the second location using the one or more inertial sensors associated with the mobile device. In some embodiments, the method may include switching the mobile device from the inactive state to the active state.

### CROSS-REFERENCE TO RELATED APPLICATIONS

This application claims priority pursuant to 35 U.S.C. 119 (a) to Indian application Ser. No. 20/231,1051294, filed Jul. 31, 2023, which application is incorporated herein by reference in its entirety.

### TECHNOLOGICAL FIELD

Embodiments of the present disclosure relate generally to systems, apparatuses, methods, and computer program products for optimizing battery consumption rate of a mobile device.

### BACKGROUND

Applicant has identified many technical challenges and difficulties associated with systems, apparatuses, methods, and computer program products for optimizing battery consumption rate of a mobile device. Through applied effort, ingenuity, and innovation, Applicant has solved problems related to systems, apparatuses, methods, and computer program products for optimizing battery consumption rate of a mobile device by developing solutions embodied in the present disclosure, which are described in detail below.

### BRIEF SUMMARY

Various embodiments described herein relate to systems, apparatuses, methods, and computer program products for optimizing battery consumption rate of a mobile device.

In accordance with one aspect of the disclosure, a method is provided. In some embodiments, the computer implemented method may include identifying map data representing a physical layout of a building and one or more locations in the building. In some embodiments, the computer implemented method may include determining that a mobile device is moving from a first location of the one or more locations in the building to a second location of the one or more locations in the building using one or more inertial sensors associated with the mobile device. In some embodiments, the computer implemented method may include in response to the determination that the mobile device is moving from the first location in the building to the second location in the building, switching the mobile device from an active state to an inactive state. In some embodiments, the computer implemented method may include determining that the mobile device has reached the second location using the one or more inertial sensors associated with the mobile device. In some embodiments, the computer implemented method may include in response to the determination that the mobile device has reached the second location, switching the mobile device from the inactive state to the active state.

In some embodiments, the computer implemented method may include providing a first instruction to perform one or more picking operations at the second location.

In some embodiments, the computer implemented method may include receiving an indication of performance of the one or more picking operations. In some embodiments, the computer implemented method may include providing a second instruction to perform one or more other picking operations at a third location.

In some embodiments, the computer implemented method may include providing directions to the third location from the second location.

In some embodiments, switching the mobile device from the active state to the inactive state comprises disconnecting the mobile device from one or more of a cellular network, a global positioning system network, a Wi-Fi network, or a Bluetooth network.

In some embodiments, switching the mobile device from the inactive state to the active state comprises connecting the mobile device from one or more of a cellular network, a global positioning system network, a Wi-Fi network, or a Bluetooth network.

In some embodiments, the computer implemented method may include generating the map data. In some embodiments, the map data is generated based at least in part on location data indicating a plurality of item locations. In some embodiments, the location data is generated based at least in part on the mobile device determining that an item is present at one or more of the one or more locations.

In some embodiments, the mobile device is associated with a first battery consumption rate when in the active state.

In some embodiments, the mobile device is associated with a second battery consumption rate when in the inactive state.

In some embodiments, the first battery consumption rate is greater than the second battery consumption rate.

In accordance with another aspect of the disclosure, an apparatus is provided. In some embodiments, the apparatus may include at least one processor and at least one non-transitory memory including computer-coded instructions thereon. In some embodiments, the computer-coded instructions, with the at least one processor, cause the apparatus to identify map data representing a physical layout of a building and one or more locations in the building. In some embodiments, the computer-coded instructions, with the at least one processor, cause the apparatus to determine that a mobile device is moving from a first location of the one or more locations in the building to a second location of the one or more locations in the building using one or more inertial sensors associated with the mobile device. In some embodiments, the computer-coded instructions, with the at least one processor, cause the apparatus to in response to the determination that the mobile device is moving from the first location in the building to the second location in the building, switch the mobile device from an active state to an inactive state. In some embodiments, the computer-coded instructions, with the at least one processor, cause the apparatus to determine that the mobile device has reached the second location using the one or more inertial sensors associated with the mobile device. In some embodiments, the computer-coded instructions, with the at least one processor, cause the apparatus to in response to the determination that the mobile device has reached the second location, switch the mobile device from the inactive state to the active state.

In some embodiments, the computer-coded instructions, with the at least one processor, cause the apparatus to provide a first instruction to perform one or more picking operations at the second location.

In some embodiments, the computer-coded instructions, with the at least one processor, cause the apparatus to receive an indication of performance of the one or more picking operations. In some embodiments, the computer-coded instructions, with the at least one processor, cause the apparatus to provide a second instruction to perform one or more other picking operations at a third location.

In some embodiments, the computer-coded instructions, with the at least one processor, cause the apparatus to provide directions to the third location from the second location.

In some embodiments, switching the mobile device from the active state to the inactive state comprises disconnecting the mobile device from one or more of a cellular network, a global positioning system network, a Wi-Fi network, or a Bluetooth network.

In some embodiments, switching the mobile device from the inactive state to the active state comprises connecting the mobile device from one or more of a cellular network, a global positioning system network, a Wi-Fi network, or a Bluetooth network.

In some embodiments, the computer-coded instructions, with the at least one processor, cause the apparatus to generate the map data. In some embodiments, the map data is generated based at least in part on location data indicating a plurality of item locations. In some embodiments, the location data is generated based at least in part on the mobile device determining that an item is present at one or more of the one or more locations.

In some embodiments, the mobile device is associated with a first battery consumption rate when in the active state.

In some embodiments, the mobile device is associated with a second battery consumption rate when in the inactive state.

In some embodiments, the first battery consumption rate is greater than the second battery consumption rate.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for identifying map data representing a physical layout of a building and one or more locations in the building. In some embodiments, the computer program code, in execution with at least one processor, configures the computer program product for determining that a mobile device is moving from a first location of the one or more locations in the building to a second location of the one or more locations in the building using one or more inertial sensors associated with the mobile device. In some embodiments, the computer program code, in execution with at least one processor, configures the computer program product for in response to the determination that the mobile device is moving from the first location in the building to the second location in the building, switching the mobile device from an active state to an inactive state. In some embodiments, the computer program code, in execution with at least one processor, configures the computer program product for determining that the mobile device has reached the second location using the one or more inertial sensors associated with the mobile device. In some embodiments, the computer program code, in execution with at least one processor, configures the computer program product for in response to the determination that the mobile device has reached the second location, switching the mobile device from the inactive state to the active state.

In some embodiments, the computer program code, in execution with at least one processor, configures the computer program product for providing a first instruction to perform one or more picking operations at the second location.

In some embodiments, the computer program code, in execution with at least one processor, configures the computer program product for receiving an indication of performance of the one or more picking operations. In some embodiments, the computer program code, in execution with at least one processor, configures the computer program product for providing a second instruction to perform one or more other picking operations at a third location.

In some embodiments, the computer program code, in execution with at least one processor, configures the computer program product for providing directions to the third location from the second location.

In some embodiments, switching the mobile device from the active state to the inactive state comprises disconnecting the mobile device from one or more of a cellular network, a global positioning system network, a Wi-Fi network, or a Bluetooth network.

In some embodiments, switching the mobile device from the inactive state to the active state comprises connecting the mobile device from one or more of a cellular network, a global positioning system network, a Wi-Fi network, or a Bluetooth network.

In some embodiments, the computer program code, in execution with at least one processor, configures the computer program product for generating the map data. In some embodiments, the map data is generated based at least in part on location data indicating a plurality of item locations. In some embodiments, the location data is generated based at least in part on the mobile device determining that an item is present at one or more of the one or more locations.

In some embodiments, the mobile device is associated with a first battery consumption rate when in the active state.

In some embodiments, the mobile device is associated with a second battery consumption rate when in the inactive state.

In some embodiments, the first battery consumption rate is greater than the second battery consumption rate.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an environment in which embodiments of the present disclosure may operate;

FIG. 2 illustrates an example block diagram of an example apparatus that may be specially configured in accordance with an example embodiment of the present disclosure;

FIG. 3 illustrates an example mobile device in accordance with an example embodiment of the present disclosure;

FIG. 4 illustrates example map data in accordance with an example embodiment of the present disclosure;

FIG. 5 illustrates an example mobile device in accordance with an example embodiment of the present disclosure;

FIG. 6 illustrates an example mobile device in accordance with an example embodiment of the present disclosure; and

FIG. 7 illustrates a flowchart of an example method in accordance with one or more embodiments of the present disclosure.

### DETAILED DESCRIPTION

Example embodiments will be described more fully hereinafter with reference to the accompanying drawings, in which some, but not all embodiments of disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

### Overview

Example embodiments disclosed herein address technical problems associated with systems, apparatuses, methods, and computer program products for optimizing battery consumption rate of a mobile device. As would be understood by one skilled in the field to which this disclosure pertains, there are numerous example scenarios in which a user may use systems, apparatuses, methods, and computer program products for optimizing battery consumption rate of a mobile device.

In many applications, it may be desirable to optimize the battery consumption rate of a mobile device. For example, it may be desirable to optimize the consumption rate of a mobile device that is used by a user (e.g., a worker) for performing picking operations in a building. In such examples, a mobile device may be configured to instruct a user which picking operations to perform (e.g., which items to pick), and/or determine the location of the mobile device within the building (e.g., such that the mobile device can instruct a user to perform a particular picking operation at a particular location in the building). After performing a picking operation, a user may move to another location to perform another picking operation. In some examples, it may not be necessary for the mobile device to be in an active state. As such, it may be desirable to switch the mobile device to an inactive state while the user is moving such that the battery rate consumption of the mobile device is optimized.

Example solutions for optimizing the battery consumption rate of a mobile device include, for example, causing at least some of the functionalities of the mobile device to become inactive when a user is transitioning between locations where the user performs picking operations. However, in such example solutions the mobile device is connected to one or more networks (e.g., a cellular network, a global positioning system network, a Wi-Fi network, and/or a Bluetooth network) and/or the user interface may be active in order to determine the user's location (e.g., such that the user can properly perform picking operations and/or the mobile device may be switched back to an active state when the user reaches the location associated with the next picking operation). As such, in such example solutions the battery consumption rate of the mobile device may not be fully optimized because the mobile device remains connected to one or more networks and/or the user interface remains active when the mobile device is in the inactive state.

Thus, to address these and/or other issues related to systems, apparatuses, methods, and computer program products for optimizing battery consumption rate of a mobile device, example systems, apparatuses, and/or methods for optimizing battery consumption rate of a mobile device are disclosed herein. For example, an embodiment in this disclosure, described in greater detail below, includes a method that includes identifying map data representing a physical layout of a building and one or more locations in the building. In some embodiments, the method includes determining that a mobile device is moving from a first location of the one or more locations in the building to a second location of the one or more locations in the building using one or more inertial sensors associated with the mobile device. In some embodiments, the method includes in response to the determination that the mobile device is moving from the first location in the building to the second location in the building, switching the mobile device from an active state to an inactive state. In some embodiments, the method includes determining that the mobile device has reached the second location using the one or more inertial sensors associated with the mobile device. In some embodiments, the method includes in response to the determination that the mobile device has reached the second location, switching the mobile device from the inactive state to the active state. Accordingly, the systems, apparatuses, methods, and computer program products provided herein enable optimizing of the battery rate consumption of a mobile device by using inertial sensors to determine when a mobile device is moving from a first location to a second location and/or when a mobile device has reached the second location.

### Example Systems and Apparatuses

Embodiments of the present disclosure herein include systems, apparatuses, methods, and computer program products for optimizing battery consumption rate of a mobile device. It should be readily appreciated that the embodiments of the apparatus, systems, methods, and computer program product described herein may be configured in various additional and alternative manners in addition to those expressly described herein.

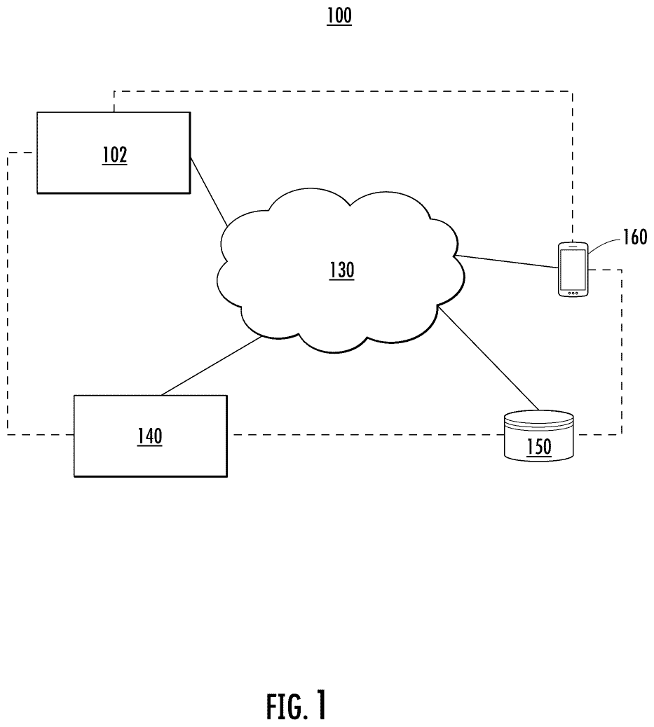

FIG. 1 illustrates an exemplary block diagram of an environment 100 in which embodiments of the present disclosure may operate. Specifically, FIG. 1 illustrates a building 102. In some embodiments, for example, the building 102 may be any type of building associated with a user associated with the environment 100. In this regard, the building 102 may, for example, be a warehouse industrial building, office building, building associated with a plant, and/or the like. For example, the building 102 may be a warehouse in which picking operations related to items stored in the warehouse may be performed.

The network 130 may be embodied in any of a myriad of network configurations. In some embodiments, the network 130 may be a public network (e.g., the Internet). In some embodiments, the network 130 may be a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

In some embodiments, the environment 100 may include a mobile device optimization system 140. In some embodiments, for example, the mobile device optimization system 140 may be configured to optimize one or more mobile devices (e.g., a mobile device 160). The mobile device optimization system 140 may be electronically and/or communicatively coupled to the building 102, one or more databases 150, and/or the mobile device 160. The mobile device optimization system 140 may be located remotely, in proximity of, and/or within the building 102. In some embodiments, the mobile device 160 may include one or more inertial sensors 302. In some embodiments, the one or more inertial sensors 302 may include one or more of a direction sensor 304, a speed sensor 306, and/or an acceleration sensor 308.

In some embodiments, the mobile device optimization system 140 is configured via hardware, software, firmware, and/or a combination thereof, to perform data intake of one or more types of data associated with one or more of the building 102, the one or more databases 150, and/or the mobile device 160 (e.g., using at least the one or more inertial sensors 302). Additionally or alternatively, in some embodiments, the mobile device optimization system 140 is configured via hardware, software, firmware, and/or a combination thereof, to generate and/or transmit command(s) that control, adjust, or otherwise impact operations of one or more of the building 102, the one or more databases 150, and/or the mobile device 160 (e.g., using at least the one or more inertial sensors 302). Additionally or alternatively still, in some embodiments, the mobile device 160 is configured via hardware, software, firmware, and/or a combination thereof, to perform data reporting and/or other data output process(es) associated with monitoring or otherwise analyzing operations of the building 102, the one or more databases 150, and/or the mobile device 160. For example, in various embodiments, the mobile device optimization system 140 may be configured to execute and/or perform one or more operations and/or functions described herein.

The one or more databases 150 may be configured to receive, store, and/or transmit data. In some embodiments, the one or more databases 150 may be associated with data associated with the building 102, the mobile device optimization system 140, and/or the mobile device 160. In some embodiments, the data may be received from the building 102, the mobile device optimization system 140, and/or the mobile device 160. In some embodiments, the one or more databases 150 may be associated with data received from the building 102, the mobile device optimization system 140, and/or the mobile device 160 in real-time. Additionally or alternatively, the one or more databases 150 may be associated with data received from the building 102, the mobile device optimization system 140, and/or the mobile device 160 on a periodic basis (e.g., the data may be received from the building 102, the mobile device optimization system 140, and/or the mobile device 160 once per day). Additionally or alternatively, the one or more databases 150 may be associated with data received from the building 102, the mobile device optimization system 140, and/or the mobile device 160 in response to a request for the data. Additionally or alternatively, the one or more databases 150 may be associated with data inputted (e.g., by a user) into the mobile device optimization system 140 and/or the mobile device 160.

The mobile device 160 may be associated with users of the mobile device optimization system 140. In various embodiments, the mobile device 160 may generate and/or transmit a message, alert, or indication to a user. Additionally, or alternatively, a mobile device 160 may be utilized by a user to remotely access the mobile device optimization system 140. This may be by, for example, an application operating on the mobile device 160. The mobile device 160 may be located remotely, in proximity of, and/or within the building 102. In some embodiments, the mobile device 160 is configured via hardware, software, firmware, and/or a combination thereof, to perform data intake of one or more types of data associated with one or more of the building 102 and/or the mobile device optimization system 140. Additionally or alternatively, in some embodiments, the mobile device 160 is configured via hardware, software, firmware, and/or a combination thereof, to generate and/or transmit command(s) that control, adjust, or otherwise impact operations of one or more of the building 102, the one or more databases 150, and/or the mobile device optimization system 140. Additionally or alternatively still, in some embodiments, the mobile device 160 is configured via hardware, software, firmware, and/or a combination thereof, to perform data reporting and/or other data output process(es) associated with monitoring or otherwise analyzing operations of the building 102, the one or more databases 150, and/or the mobile device optimization system 140. For example, in various embodiments, the mobile device 160 may be configured to execute and/or perform one or more operations and/or functions described herein.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the mobile device optimization system 140 may include the one or more databases 150 and/or the mobile device 160, which may collectively be located in or at the building 102.

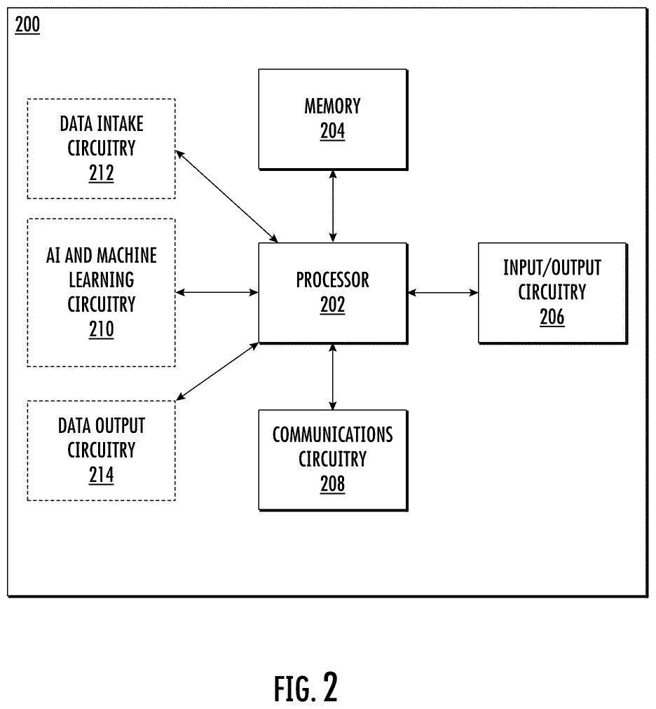

FIG. 2 illustrates an exemplary block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. For example, the computing apparatus 200 may be embodied as one or more of a specifically configured personal computing apparatus, a specifically configured cloud based computing apparatus, a specifically configured embedded computing device (e.g., configured for edge computing, and/or the like). Examples of an apparatus 200 may include, but is not limited to, a mobile device optimization system 140, the one or more databases 150, and/or a mobile device 160. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as computing apparatus 200 of a mobile device optimization system 140 or of a mobile device 160 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuity 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys, a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more sensors, and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of the building 102. In some embodiments, the data intake circuitry 212 includes hardware, software, firmware, and/or a combination thereof, that communicates with one or more sensor(s) unit(s), and/or the like within the building 102 to receive particular data associated with such operations of the building 102. Additionally or alternatively, in some embodiments, the data intake circuitry 212 includes hardware, software, firmware, and/or a combination thereof, that retrieves particular data associated with the building 102 from one or more data repository/repositories accessible to the apparatus 200.

Al and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data.

Additionally or alternatively, in some embodiments, the AI and machine learning circuitry 210 includes hardware, software, firmware, and/or a combination thereof, that embodies or retrieves a trained machine learning model, AI, and/or other specially configured model utilized to process inputted data. Additionally or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect to the AI and machine learning circuitry 210.

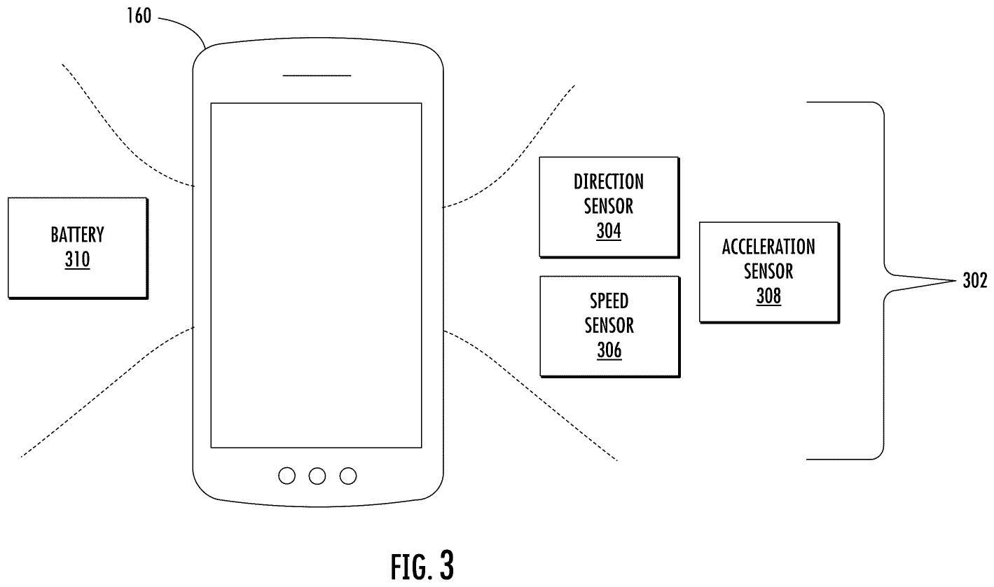

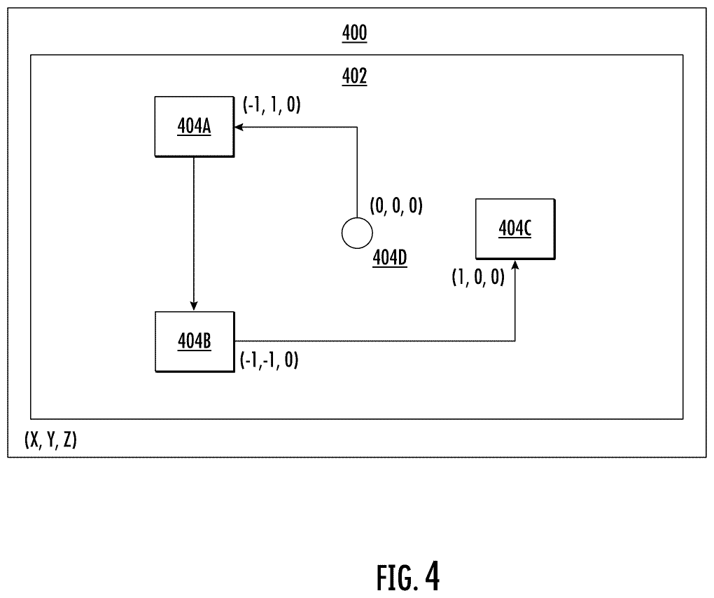

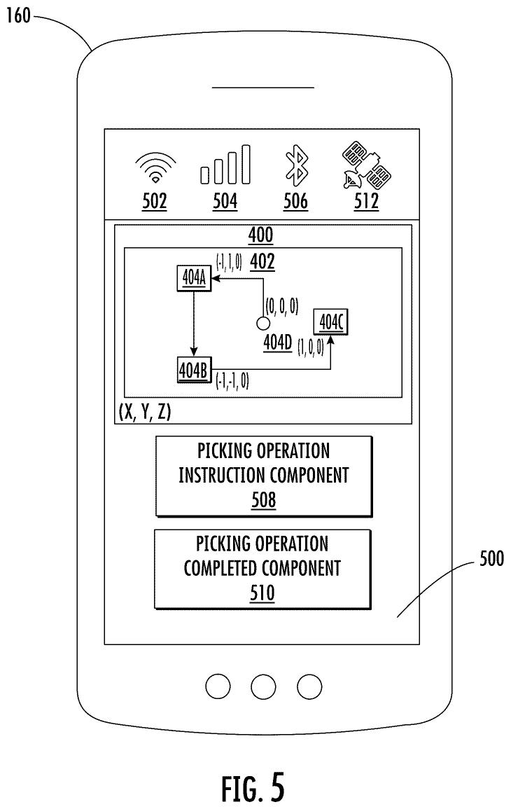

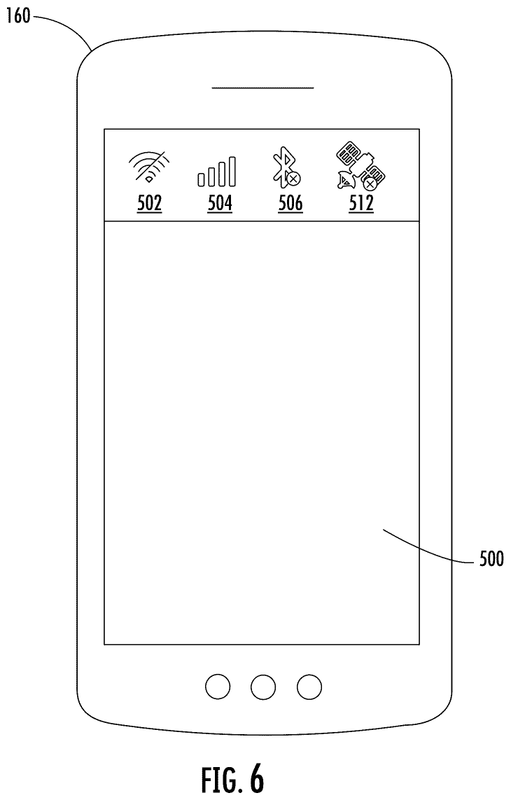

With reference to FIGS. 1-6, in some embodiments, the mobile device 160 may be configured to identify map data 400. In some embodiments, the map data 400 may represent a physical layout 402 of the building 102. Additionally or alternatively, the map data 400 may represent one or more locations 404 in the building 102. In some embodiments, at least one of the one or more locations 404 may be associated with an item. For example, a first location 404A may be associated with a first item, a second location 404B may be associated with a second item, and/or a third location 404C may be associated with a third item. In this regard, for example, the map data may include information about one or more items (e.g., information about items associated with at least one of the one or more locations). For example, the information about one or more items may indicate a product type of the one or more items.

In some embodiments, at least one of the one or more locations 404 may be associated with an origin. In this regard, for example, the origin may represent a starting location for a sequence of operations that may be performed by the mobile device 160 and/or a user associated with the mobile device 160. In some embodiments, the origin may be located at any location in the building 102. For example, the origin may be located proximate a center point of the building 102, proximate a location associated with one or more items stored in the building 102, and/or proximate an entrance to the building 102. Additionally or alternatively, the origin may be located outside the building 102. For example, the origin may be proximate another building associated with the building 102. Although four such locations are illustrated in the map data 400, it would be understood by one skilled in the field to which this disclosure pertains that the map data 400 could include more or fewer locations. For example, the map data 400 may include five locations.

In some embodiments, each of the one or more locations 404 may be associated with coordinates. In this regard, the coordinates may represent a position of a location relative to other locations of the one or more locations 404. For example, the coordinates may represent a position of a location relative to a location that is the origin. In this regard, for example, the first location 404A may be associated with coordinates of (−1, 1, 0), the second location 404B may be associated with coordinates of (−1, −1, 0), the third location 404C may be associated with coordinates of (1, 0, 0), a fourth location 404D may be associated with coordinates of (0, 0, 0) (e.g., the fourth location 404D is the origin).

In some embodiments, the mobile device 160 may be configured to determine that the mobile device 160 is moving from one location of the one or more locations 404 to another location of the one or more locations 404 (e.g., a user associated with the mobile device 160 is moving between one or more of the one or more locations 404). For example, the mobile device 160 may be configured to determine that the mobile device 160 is moving from the first location 404A to the second location 404B. As another example, the mobile device 160 may be configured to determine that the mobile is moving from the fourth location 404D to the first location 404A.

In some embodiments, the mobile device 160 may be configured to determine that the mobile device 160 is moving from one location of the one or more locations 404 to another location of the one or more locations 404 using the one or more inertial sensors 302 of the mobile device 160. In this regard, the mobile device 160 may be configured to determine that the mobile device 160 is moving from one location of the one or more locations 404 to another location of the one or more locations 404 using one or more of the direction sensor 304, the speed sensor 306, and/or the acceleration sensor 308. For example, the mobile device 160 may be configured to determine that the mobile device 160 is moving from the first location 404A to the second location 404B using one or more of the direction sensor 304, the speed sensor 306, and/or the acceleration sensor 308. Said differently, for example, using the one or more inertial sensors 302, the mobile device 160 may be configured to determine when the mobile device 160 is moving away from the coordinates associated with one of the one or more locations 404 to coordinates associated with another of the one or more locations 404 in the building 102.

In some embodiments, the mobile device 160 may be associated with a first battery consumption rate when in the active state (e.g., a battery 310 of the mobile device 160 may be consumed at the first battery consumption rate when the mobile device 160 is in the active state). In some embodiments, the mobile device 160 may be associated with a second battery consumption rate when in the inactive state (e.g., the battery 310 of the mobile device 160 may be consumed at the second battery consumption rate when the mobile device 160 is in the inactive state). In some embodiments, the first battery consumption rate may be greater than the second battery consumption rate. Said differently, the battery 310 of the mobile device 160 may be consumed at a greater rate when the mobile device 160 is in the active state than when the mobile device 160 is in the inactive state.

In some embodiments, in response to the determination that the mobile device 160 is moving from one location of the one or more locations 404 to another location of the one or more locations 404 in the building 102, the mobile device 160 may be configured to switch the mobile device 160 from the active state to the inactive state. In some embodiments, for example, switching the mobile device 160 from the active state to the inactive state may include disconnecting the mobile device 160 from a cellular network (e.g., cellular network 504). Additionally or alternatively, switching the mobile device 160 from the active state to the inactive state may include disconnecting the mobile device 160 from a global positioning system network (e.g., global positioning system network 512). Additionally or alternatively, switching the mobile device 160 from the active state to the inactive state may include disconnecting the mobile device 160 from a Wi-Fi network (e.g., Wi-Fi network 502). Additionally or alternatively, switching the mobile device 160 from the active state to the inactive state may include disconnecting the mobile device 160 from a Bluetooth network (e.g., Bluetooth network 506). Additionally or alternatively, switching the mobile device 160 from the active state to the inactive state may include deactivating a user interface 500 of the mobile device 160. Said differently, for example, in the inactive state the mobile device 160 may be configured such that much of the functionality of the mobile device 160 is inactive. In this regard, for example, the second battery consumption rate may be less than the first battery consumption rate (e.g., because the functionality of the mobile device 160 is less when the mobile device 160 is in the inactive state than when the mobile device 160 is in the active state).

In some embodiments, switching the mobile device 160 from the active state to the inactive state may not have an impact on the one or more inertial sensors 302 of the mobile device 160. For example, switching the mobile device 160 from the active state to the inactive state may not include deactivating the one or more inertial sensors 302 such that the one or more inertial sensors 302 may function when the mobile device 160 is in an inactive state. In this regard, for example, the mobile device 160 may be configured such that the mobile device 160 may be able to determine its location in the building 102 even when the mobile device 160 is in the inactive state (e.g., using at least the inertial sensors 302).

In some embodiments, the mobile device 160 may be configured to determine that the mobile device 160 has reached one location of the one or more locations 404 from another location of the one or more locations 404 using the one or more inertial sensors 302 of the mobile device 160. In this regard, the mobile device 160 may be configured to determine that the mobile device 160 has reached one location of the one or more locations 404 from another location of the one or more locations 404 using one or more of the direction sensor 304, the speed sensor 306, and/or the acceleration sensor 308. For example, the mobile device 160 may be configured to determine that the mobile device 160 has reached the second location 404B from the first location 404A using one or more of the direction sensor 304, the speed sensor 306, and/or the acceleration sensor 308. Said differently, for example, using the one or more inertial sensors 302, the mobile device 160 may be configured to determine when the mobile device 160 has reached the coordinates associated with one of the one or more locations 404 from coordinates associated with another of the one or more locations 404 in the building 102.

In some embodiments, in response to the determination that the mobile device 160 has reached one location of the one or more locations 404 from another location of the one or more locations 404 in the building 102, the mobile device 160 may be configured to switch the mobile device 160 from the inactive state to the active state. In some embodiments, for example, switching the mobile device 160 from the inactive state to the active state may include connecting the mobile device 160 to a cellular network (e.g., cellular network 504). Additionally or alternatively, switching the mobile device 160 from the inactive state to the active state may include connecting the mobile device 160 to a global positioning system network (e.g., global positioning system network 512). Additionally or alternatively, switching the mobile device 160 from the inactive state to the active state may include connecting the mobile device 160 to a Wi-Fi network (e.g., Wi-Fi network 502). Additionally or alternatively, switching the mobile device 160 from the inactive state to the active state may include connecting the mobile device 160 to a Bluetooth network (e.g., Bluetooth network 506). Additionally or alternatively, switching the mobile device 160 from the inactive state to the active state may include activating the user interface 500 of the mobile device 160. Said differently, for example, in the active state the mobile device 160 may be configured such that much or all of the functionality of the mobile device 160 is active. In this regard, for example, the first battery consumption rate may be greater than the second battery consumption rate (e.g., because the functionality of the mobile device 160 is greater when the mobile device 160 is in the active state than when the mobile device 160 is in the inactive state).

In some embodiments, switching the mobile device 160 from the active state to the inactive state may not have an impact on the one or more inertial sensors 302 of the mobile device 160. For example, switching the mobile device 160 from the active state to the inactive state may not include activating (e.g., the one or more inertial sensors 302 may already be active) the one or more inertial sensors 302 such that the one or more inertial sensors 302 may function when the mobile device 160 is in the active state. In this regard, for example, the mobile device 160 may be configured such that the mobile device 160 may be able to determine its location in the building 102 even when the mobile device 160 is in the active state and/or the inactive (e.g., using at least the inertial sensors 302). Said differently, the mobile device 160 may be configured such that the battery consumption rate of the mobile device 160 may be optimized (e.g., the mobile device 160 has a lower battery consumption rate when in the inactive state) while still being able to determine the position of the mobile device 160 in the building 102 (e.g., determine when the mobile device 160 has reached a location in the building 102).

In some embodiments, the mobile device 160 and/or the mobile device optimization system 140 may be configured to provide an instruction to perform one or more picking operations at one or more of the one or more locations 404 (e.g., a picking operation to pick one or more items). For example, the mobile device 160 and/or the mobile device optimization system 140 may be configured to provide an instruction to perform one or more picking operations at the second location 404B. In some embodiments, the instruction to perform one or more picking operations may be provided via a picking operation instruction component 508 of the user interface 500. For example, the instruction to perform one or more picking operations at the second location 404B may be provided via the picking operation instruction component 508 of the user interface 500. In some embodiments, the instruction to perform one or more picking operations may include information about one or more products that are to be picked by performing the one or more picking operations.

In some embodiments, the mobile device 160 and/or the mobile device optimization system 140 may be configured to receive an indication of performance of one or more picking operations. For example, the mobile device 160 and/or the mobile device optimization system 140 may be configured to receive an indication of performance of one or more picking operations at the second location 404B. In some embodiments, the indication of performance of one or more picking operations may be received via a picking operation completed component 510 of the user interface 500. For example, the indication of performance of one or more picking operations at the second location 404B may be received via the picking operation completed component 510 of the user interface 500.

In some embodiments, the mobile device 160 and/or the mobile device optimization system 140 may be configured to provide an instruction to perform one or more picking operations at another of the one or more locations 404 (e.g., after the mobile device 160 and/or the mobile device optimization system 140 has received an indication of performance of one or more picking operations at one of the one or more locations 404). For example, the mobile device 160 and/or the mobile device optimization system 140 may be configured to provide an instruction to perform one or more picking operations at the third location 404C (e.g., after the mobile device 160 and/or the mobile device optimization system 140 has received an indication of performance of one or more picking operations at the second location 404B). In some embodiments, the instruction to perform one or more picking operations may be provided via the picking operation instruction component 508 of the user interface 500. For example, the instruction to perform one or more picking operations at the third location 404C may be provided via the picking operation instruction component 508 of the user interface 500.

In some embodiments, the mobile device 160 and/or the mobile device optimization system 140 may be configured to provide directions to one location of the one or more locations 404 from another location of the one or more locations 404 of the building 102. For example, the mobile device 160 and/or the mobile device optimization system 140 may be configured to provide directions to the third location 404C from the second location 404B. In this regard, for example, the mobile device 160 and/or the mobile device optimization system 140 may be configured to provide directions to one location of the one or more locations 404 to another location of the one or more locations 404 of the building 102 by displaying the map data 400 on the user interface 500. For example, the mobile device 160 and/or the mobile device optimization system 140 may be configured to provide directions to the third location 404C from the second location 404B by displaying the map data 400 on the user interface 500.

In some embodiments, the mobile device 160 may be configured to generate the map data 400 (e.g., the mobile device 160 may be configured to identify map data 400 that the mobile device 160 has previously generated). In some embodiments, the map data 400 may be generated based at least in part on location data. In this regard, for example, the location data may be generated based at least in part on the mobile device 160 determining that an item is present at one or more of the one or more locations 404 and/or the coordinates at the one or more of the one or more locations 404. For example, a user associated with the mobile device 160 may start at the fourth location 404D (e.g., the origin), move to the first location 404A, pick an item at the first location 404A, and indicate to the mobile device 160 that an item has been picked at the first location 404A. Then, the mobile device 160 may be configured to determine that an item is present at the first location 404A and, using at least the inertial sensors 302, determine the distance and direction that the mobile device 160 has travelled when the mobile device 160 moved from the fourth location 404D to the first location 404A. For example, when the fourth location 404D is associated with coordinates of (0, 0, 0) and the first location 404A is associated with coordinates of (−1, 1, 0), the mobile device 160 may be configured to determine that the mobile device 160 has moved one unit forward and one unit left (e.g., one meter forward and one meter left). In this regard, the mobile device 160 may be configured to generate location data that indicates which items are located at one or more of the one or more locations 404 and/or the coordinates of the one or more locations 404, which may be used by the mobile device 160 to generate the map data 400.

In some embodiments, the mobile device 160 may be configured to regularly generate updated map data. In this regard, for example, if a user associated with the mobile device 160 moves from one of the one or more locations 404 (e.g., a known location in the map data 400) to another location (e.g., a fifth location that is not a known location in the map data 400), picks an item at the other location, and indicates to the mobile device 160 that an item has been picked at the other location, the mobile device 160 may be configured to determine that an item is present at the other location (e.g., the fifth location) and, using at least the inertial sensors 302, determine the distance and direction that the mobile device 160 has travelled when the mobile device 160 moved from the one of the one or more locations 404 to the other location. In this regard, the mobile device 160 may be configured to generate updated location data that indicates which items are located at the other location (e.g., the fifth location) and/or the coordinates of the other location, which may be used by the mobile device 160 to generate the updated map data.

In some embodiments, the mobile device 160 may be configured to receive the map data 400 from the mobile device optimization system 140 (e.g., the mobile device 160 may be configured to identify map data 400 that the mobile device 160 has received from the mobile device optimization system 140). In this regard, for example, the mobile device optimization system 140 may be configured to generate the map data 400 and provide the map data 400 to the mobile device 160. As another example, the mobile device optimization system 140 may be configured to receive the map data 400 from one or more other mobile devices and provide the map data 400 received from the one or more other mobile devices to the mobile device 160.

### Example Method

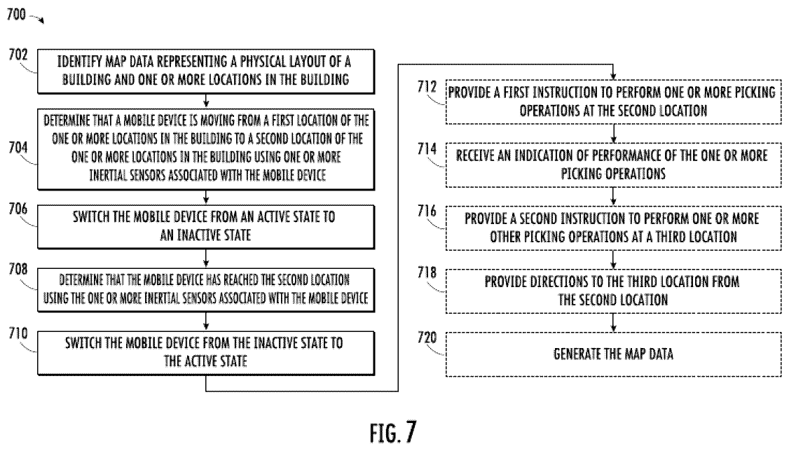

Referring now to FIG. 7, a flowchart providing an example method 700 is illustrated. In this regard, FIG. 7 illustrates operations that may be performed by the mobile device optimization system 140, the mobile device 160, the building 102, and/or the like. In some embodiments, the example method 700 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 700.

As shown in block 702, the method may include identifying map data representing a physical layout of a building and one or more locations in the building. As described above, in some embodiments, the map data may represent a physical layout of the building. Additionally or alternatively, the map data may represent one or more locations in the building. In some embodiments, at least one of the one or more locations may be associated with an item. For example, a first location may be associated with a first item, a second location may be associated with a second item, and/or a third location may be associated with a third item. In this regard, for example, the map data may include information about one or more items (e.g., information about items associated with at least one of the one or more locations). For example, the information about one or more items may indicate a product type of the one or more items.

In some embodiments, at least one of the one or more locations may be associated with

an origin. In this regard, for example, the origin may represent a starting location for a sequence of operations that may be performed by the mobile device and/or a user associated with the mobile device. In some embodiments, the origin may be located at any location in the building. For example, the origin may be located proximate a center point of the building, proximate a location associated with one or more items stored in the building, and/or proximate an entrance to the building. Additionally or alternatively, the origin may be located outside the building. For example, the origin may be proximate another building associated with the building. Although four such locations are illustrated in the map data, it would be understood by one skilled in the field to which this disclosure pertains that the map data could include more or fewer locations. For example, the map data may include five locations.

In some embodiments, each of the one or more locations may be associated with coordinates. In this regard, the coordinates may represent a position of a location relative to other locations of the one or more locations. For example, the coordinates may represent a position of a location relative to a location that is the origin. In this regard, for example, the first location may be associated with coordinates of (−1, 1, 0), the second location may be associated with coordinates of (−1, −1, 0), the third location may be associated with coordinates of (1, 0, 0), a fourth location may be associated with coordinates of (0, 0, 0) (e.g., the fourth location is the origin).

As shown in block 704, the method may include determining that a mobile device is moving from a first location of the one or more locations in the building to a second location of the one or more locations in the building using one or more inertial sensors associated with the mobile device. As described above, in some embodiments, the mobile device may be configured to determine that the mobile device is moving from one location of the one or more locations to another location of the one or more locations using one or more of the direction sensor, the speed sensor, and/or the acceleration sensor. For example, the mobile device may be configured to determine that the mobile device is moving from the first location to the second location using one or more of the direction sensor, the speed sensor, and/or the acceleration sensor. Said differently, for example, using the one or more inertial sensors, the mobile device may be configured to determine when the mobile device is moving away from the coordinates associated with one of the one or more locations to coordinates associated with another of the one or more locations in the building.

In some embodiments, the mobile device may be associated with a first battery consumption rate when in the active state (e.g., a battery of the mobile device may be consumed at the first battery consumption rate when the mobile device is in the active state). In some embodiments, the mobile device may be associated with a second battery consumption rate when in the inactive state (e.g., the battery of the mobile device may be consumed at the second battery consumption rate when the mobile device is in the inactive state). In some embodiments, the first battery consumption rate may be greater than the second battery consumption rate. Said differently, the battery of the mobile device may be consumed at a greater rate when the mobile device is in the active state than when the mobile device is in the inactive state.

As shown in block 706, the method may include in response to the determination that the mobile device is moving from the first location in the building to the second location in the building, switching the mobile device from an active state to an inactive state. As described above, in some embodiments, for example, switching the mobile device from the active state to the inactive state may include disconnecting the mobile device from a cellular network (e.g., cellular network). Additionally or alternatively, switching the mobile device from the active state to the inactive state may include disconnecting the mobile device from a global positioning system network (e.g., global positioning system network). Additionally or alternatively, switching the mobile device from the active state to the inactive state may include disconnecting the mobile device from a Wi-Fi network (e.g., Wi-Fi network). Additionally or alternatively, switching the mobile device from the active state to the inactive state may include disconnecting the mobile device from a Bluetooth network (e.g., Bluetooth network). Additionally or alternatively, switching the mobile device from the active state to the inactive state may include deactivating a user interface of the mobile device. Said differently, for example, in the inactive state the mobile device may be configured such that much of the functionality of the mobile device is inactive. In this regard, for example, the second battery consumption rate may be less than the first battery consumption rate (e.g., because the functionality of the mobile device is less when the mobile device is in the inactive state than when the mobile device is in the active state).

In some embodiments, switching the mobile device from the active state to the inactive state may not have an impact on the one or more inertial sensors of the mobile device. For example, switching the mobile device from the active state to the inactive state may not include deactivating the one or more inertial sensors such that the one or more inertial sensors may function when the mobile device is in an inactive state. In this regard, for example, the mobile device may be configured such that the mobile device may be able to determine its location in the building even when the mobile device is in the inactive state (e.g., using at least the inertial sensors).

As shown in block 708, the method may include determining that the mobile device has reached the second location using the one or more inertial sensors associated with the mobile device. As described above, in some embodiments, the mobile device may be configured to determine that the mobile device has reached one location of the one or more locations from another location of the one or more locations using one or more of the direction sensor, the speed sensor, and/or the acceleration sensor. For example, the mobile device may be configured to determine that the mobile device has reached the second location from the first location using one or more of the direction sensor, the speed sensor, and/or the acceleration sensor. Said differently, for example, using the one or more inertial sensors, the mobile device may be configured to determine when the mobile device has reached the coordinates associated with one of the one or more locations from coordinates associated with another of the one or more locations in the building.

As shown in block 710, the method may include in response to the determination that the mobile device has reached the second location, switching the mobile device from the inactive state to the active state. As described above, in some embodiments, for example, switching the mobile device from the inactive state to the active state may include connecting the mobile device to a cellular network (e.g., cellular network). Additionally or alternatively, switching the mobile device from the inactive state to the active state may include connecting the mobile device to a global positioning system network (e.g., global positioning system network). Additionally or alternatively, switching the mobile device from the inactive state to the active state may include connecting the mobile device to a Wi-Fi network (e.g., Wi-Fi network). Additionally or alternatively, switching the mobile device from the inactive state to the active state may include connecting the mobile device to a Bluetooth network (e.g., Bluetooth network). Additionally or alternatively, switching the mobile device from the inactive state to the active state may include activating the user interface of the mobile device. Said differently, for example, in the active state the mobile device may be configured such that much or all of the functionality of the mobile device is active. In this regard, for example, the first battery consumption rate may be greater than the second battery consumption rate (e.g., because the functionality of the mobile device is greater when the mobile device is in the active state than when the mobile device is in the inactive state).

In some embodiments, switching the mobile device from the active state to the inactive state may not have an impact on the one or more inertial sensors of the mobile device. For example, switching the mobile device from the active state to the inactive state may not include activating (e.g., the one or more inertial sensors may already be active) the one or more inertial sensors such that the one or more inertial sensors may function when the mobile device is in the active state. In this regard, for example, the mobile device may be configured such that the mobile device may be able to determine its location in the building even when the mobile device is in the active state and/or the inactive (e.g., using at least the inertial sensors). Said differently, the mobile device may be configured such that the battery consumption rate of the mobile device may be optimized (e.g., the mobile device has a lower battery consumption rate when in the inactive state) while still being able to determine the position of the mobile device in the building (e.g., determine when the mobile device has reached a location in the building).

As shown in block 712, the method may optionally include providing a first instruction to perform one or more picking operations at the second location. As described above, in some embodiments, for example, the mobile device and/or the mobile device optimization system may be configured to provide an instruction to perform one or more picking operations at the second location. In some embodiments, the instruction to perform one or more picking operations may be provided via a picking operation instruction component of the user interface. For example, the instruction to perform one or more picking operations at the second location may be provided via the picking operation instruction component of the user interface. In some embodiments, the instruction to perform one or more picking operations may include information about one or more products that are to be picked by performing the one or more picking operations.

As shown in block 714, the method may optionally include receiving an indication of performance of the one or more picking operations. As described above, in some embodiments, for example, the mobile device and/or the mobile device optimization system may be configured to receive an indication of performance of one or more picking operations at the second location.

In some embodiments, the indication of performance of one or more picking operations may be received via a picking operation completed component of the user interface. For example, the indication of performance of one or more picking operations at the second location may be received via the picking operation completed component of the user interface.

As shown in block 716, the method may optionally include providing a second instruction to perform one or more other picking operations at a third location. As described above, in some embodiments, for example, the mobile device and/or the mobile device optimization system may be configured to provide an instruction to perform one or more picking operations at the third location (e.g., after the mobile device and/or the mobile device optimization system has received an indication of performance of one or more picking operations at the second location). In some embodiments, the instruction to perform one or more picking operations may be provided via the picking operation instruction component of the user interface. For example, the instruction to perform one or more picking operations at the third location may be provided via the picking operation instruction component of the user interface.

As shown in block 718, the method may optionally include providing directions to the third location from the second location. As described above, in some embodiments, for example, the mobile device and/or the mobile device optimization system may be configured to provide directions to the third location from the second location. In this regard, for example, the mobile device and/or the mobile device optimization system may be configured to provide directions to one location of the one or more locations to another location of the one or more locations of the building by displaying the map data on the user interface. For example, the mobile device and/or the mobile device optimization system may be configured to provide directions to the third location from the second location by displaying the map data on the user interface.

As shown in block 720, the method may optionally include generating the map data. As described above, in some embodiments, the mobile device may be configured to generate the map data (e.g., the mobile device may be configured to identify map data that the mobile device has previously generated). In some embodiments, the map data may be generated based at least in part on location data. In this regard, for example, the location data may be generated based at least in part on the mobile device determining that an item is present at one or more of the one or more locations and/or the coordinates at the one or more of the one or more locations. For example, a user associated with the mobile device may start at the fourth location (e.g., the origin), move to the first location, pick an item at the first location, and indicate to the mobile device that an item has been picked at the first location. Then, the mobile device may be configured to determine that an item is present at the first location and, using at least the inertial sensors, determine the distance and direction that the mobile device has travelled when the mobile device moved from the fourth location to the first location. For example, when the fourth location is associated with coordinates of (0, 0, 0) and the first location is associated with coordinates of (−1, 1, 0), the mobile device may be configured to determine that the mobile device has moved one unit forward and one unit left (e.g., one meter forward and one meter left). In this regard, the mobile device may be configured to generate location data that indicates which items are located at one or more of the one or more locations and/or the coordinates of the one or more locations, which may be used by the mobile device to generate the map data.

In some embodiments, the mobile device may be configured to regularly generate updated map data. In this regard, for example, if a user associated with the mobile device moves from one of the one or more locations (e.g., a known location in the map data) to another location (e.g., a fifth location that is not a known location in the map data), picks an item at the other location, and indicates to the mobile device that an item has been picked at the other location, the mobile device may be configured to determine that an item is present at the other location (e.g., the fifth location) and, using at least the inertial sensors, determine the distance and direction that the mobile device has travelled when the mobile device moved from the one of the one or more locations to the other location. In this regard, the mobile device may be configured to generate updated location data that indicates which items are located at the other location (e.g., the fifth location) and/or the coordinates of the other location, which may be used by the mobile device to generate the updated map data.

In some embodiments, the mobile device may be configured to receive the map data from the mobile device optimization system (e.g., the mobile device may be configured to identify map data that the mobile device has received from the mobile device optimization system). In this regard, for example, the mobile device optimization system may be configured to generate the map data and provide the map data to the mobile device. As another example, the mobile device optimization system may be configured to receive the map data from one or more other mobile devices and provide the map data received from the one or more other mobile devices to the mobile device.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

While this specification contains many specific embodiment and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

That which is claimed:

1. A method comprising:
identifying map data representing a physical layout of a building and one or more locations in the building;
determining that a mobile device is moving from a first location of the one or more locations in the building to a second location of the one or more locations in the building using one or more inertial sensors associated with the mobile device;
in response to the determination that the mobile device is moving from the first location in the building to the second location in the building, switching the mobile device from an active state to an inactive state;
determining that the mobile device has reached the second location using the one or more inertial sensors associated with the mobile device; and
in response to the determination that the mobile device has reached the second location, switching the mobile device from the inactive state to the active state.

2. The method of claim 1, further comprising:
providing a first instruction to perform one or more picking operations at the second location.

3. The method of claim 2, further comprising:
receiving an indication of performance of the one or more picking operations; and
providing a second instruction to perform one or more other picking operations at a third location.

4. The method of claim 3, further comprising:
providing directions to the third location from the second location.

5. The method of claim 1, wherein switching the mobile device from the active state to the inactive state comprises disconnecting the mobile device from one or more of a cellular network, a global positioning system network, a Wi-Fi network, or a Bluetooth network.

6. The method of claim 1, wherein switching the mobile device from the inactive state to the active state comprises connecting the mobile device from one or more of a cellular network, a global positioning system network, a Wi-Fi network, or a Bluetooth network.

7. The method of claim 1, further comprising:
generating the map data, wherein the map data is generated based at least in part on location data indicating a plurality of item locations, wherein the location data is generated based at least in part on the mobile device determining that an item is present at one or more of the one or more locations.

8. The method of claim 1, wherein the mobile device is associated with a first battery consumption rate when in the active state.

9. The method of claim 8, wherein the mobile device is associated with a second battery consumption rate when in the inactive state.

10. The method of claim 9, wherein the first battery consumption rate is greater than the second battery consumption rate.

11. An apparatus comprising at least one processor and at least one non-transitory memory including computer-coded instructions thereon, the computer coded instructions, with the at least one processor, cause the apparatus to:
identify map data representing a physical layout of a building and one or more locations in the building;
determine that a mobile device is moving from a first location of the one or more locations in the building to a second location of the one or more locations in the building using one or more inertial sensors associated with the mobile device;
in response to the determination that the mobile device is moving from the first location in the building to the second location in the building, switch the mobile device from an active state to an inactive state;
determine that the mobile device has reached the second location using the one or more inertial sensors associated with the mobile device; and
in response to the determination that the mobile device has reached the second location, switch the mobile device from the inactive state to the active state.

12. The apparatus of claim 11, wherein the computer coded instructions, further with the at least one processor, cause the apparatus to:
provide a first instruction to perform one or more picking operations at the second location.

13. The apparatus of claim 12, wherein the computer coded instructions, further with the at least one processor, cause the apparatus to:
receive an indication of performance of the one or more picking operations; and
provide a second instruction to perform one or more other picking operations at a third location.

14. The apparatus of claim 11, wherein switching the mobile device from the active state to the inactive state comprises disconnecting the mobile device from one or more of a cellular network, a global positioning system network, a Wi-Fi network, or a Bluetooth network.

15. The apparatus of claim 11, wherein switching the mobile device from the inactive state to the active state comprises connecting the mobile device from one or more of a cellular network, a global positioning system network, a Wi-Fi network, or a Bluetooth network.

16. The apparatus of claim 11, wherein the computer coded instructions, further with the at least one processor, cause the apparatus to:
generate the map data, wherein the map data is generated based at least in part on location data indicating a plurality of item locations, wherein the location data is generated based at least in part on the mobile device determining that an item is present at one or more of the one or more locations.

17. The apparatus of claim 11, wherein the mobile device is associated with a first battery consumption rate when in the active state.

18. The apparatus of claim 17, wherein the mobile device is associated with a second battery consumption rate when in the inactive state.

19. The apparatus of claim 18, wherein the first battery consumption rate is greater than the second battery consumption rate.

20. A computer program product comprising at least one non-transitory computer-readable storage medium having computer program code stored thereon that, in execution with at least one processor, configures the computer program product for:
identifying map data representing a physical layout of a building and one or more locations in the building;
determining that a mobile device is moving from a first location of the one or more locations in the building to a second location of the one or more locations in the building using one or more inertial sensors associated with the mobile device;
in response to the determination that the mobile device is moving from the first location in the building to the second location in the building, switching the mobile device from an active state to an inactive state;
determining that the mobile device has reached the second location using the one or more inertial sensors associated with the mobile device; and
in response to the determination that the mobile device has reached the second location, switching the mobile device from the inactive state to the active state.
